(19) United States
(12) Patent Application Publication
(10) Pub. No.: US 2024/0336138 A1
(43) Pub. Date: Oct. 10, 2024

(54) Displaying a Vehicle's Movement in a Constrained Environment

(71) Applicants: Lavern Meissner, Charlotte, NC (US); Matthew Madiar, Chicago, IL (US)

(72) Inventors: Lavern Meissner, Charlotte, NC (US); Matthew Madiar, Chicago, IL (US)

(21) Appl. No.: 18/748,199

(22) Filed: Jun. 20, 2024

Related U.S. Application Data
(63) Continuation-in-part of application No. 17/816,422, filed on Jul. 31, 2022.

(51) Int. Cl. B60K 35/22; G06T 19/00

(52) U.S. Cl. CPC B60K 35/22; G06T 19/006; B60K 2360/175; B60K 2360/176; B60K 2360/177

(57) ABSTRACT

A 3D model of a vehicle and a 3D model of a constrained environment are combined. The combined models are manipulated then rendered to provide 2D representations of the 3D models. The 2D representations can be displayed on a conventional display device and replicate movement of the modelled vehicle in the actual constrained environment. Rendering the manipulated models enables the 3D models to be viewable on a 2D display screen. The 3D models can be manipulated to provide either 1^{st} person or 3^{rd} person views of a vehicle inside a constrained environment. A spline curve representing a safe pathway through the constrained environment can also be modelled in 3D, combined with other 3D models and rendered for display on a display device.

### RELATED APPLICATION

This application is a continuation-in-part of U.S. patent application Ser. No. 17/816,422 filed Jul. 31, 2022, entitled “Method and Apparatus for Determining a Backup Path.”

### BACKGROUND

As used herein the terms, backing and backing up, refer to driving a motor vehicle in a reverse direction. It is well known that safely backing a truck around obstacles in a parking lot or in a loading area to a desired destination or parking position can be difficult. When obstacles such as other vehicles surround or are even near a truck, backing it into a parking space often requires repetitive forward and backward truck movement accompanied by different steering wheel movements. A method and apparatus that helps a driver back a truck through a congested area in any parking lot and would help avoid collisions would speed truck deliveries and lower truck transportation costs, among other things.

### BRIEF DESCRIPTION OF THE FIGURES

FIG. 1A depicts an interpolating spline curve;

FIG. 1B depicts an approximating spline curve;

FIG. 2 depicts a spline curve, as defined below, which wraps around objects and has a substantially serpentine shape;

FIG. 3 is a plan or top view of a loading bay having multiple loading docks on opposite sides of the loading bay lane and a spline curve for a truck to follow backwardly to a loading dock;

FIG. 4A depicts a first apparatus embodiment for wirelessly providing steering guidance to a vehicle;

FIG. 4B depicts a second apparatus embodiment for wirelessly providing steering

guidance to a vehicle;

FIGS. 5A-5C, depict steps of a method by which a spline curve is generated for an identified vehicle needing to be backed into a parking space in a constrained environment, such as the loading bay depicted in FIG. 3;

FIG. 6A is a flow chart depicting a method of displaying on a display device movement of a vehicle through a constrained environment;

FIG. 6B is a flow chart depicting another method of displaying on a display device movement of a vehicle through a constrained environment;

FIG. 7A is a flow chart depicting method step 604 in FIG. 6A and method step 604 of FIG. 6B;

FIG. 7B is a flow chart depicting an alternate embodiment of method step 604 in FIG. 6A and method step 604 in FIG. 6B;

FIG. 8A is a flow chart depicting in greater detail, a first embodiment of steps 612 and 614 in FIG. 6A and steps 612 and 614 in FIG. 6B;

FIG. 8B is a flow chart depicting in greater detail, an alternate embodiment of step 612 and 614 in FIG. 6.

FIG. 9 depicts a third-person view of a constrained environment and a third person view of a vehicle about to enter the constrained environment as they would be displayed on a computer display screen;

FIG. 10 depicts a first-person view of a portion of a spline curve over laid a Cartesian coordinate system, as the spline curve and coordinate system would be displayed on a computer display screen.

### DETAILED DESCRIPTION

Backing a truck or other vehicle into a parking space requires of course moving the vehicle backward, i.e., in a reverse direction. When there is no straight or substantially straight-line for the vehicle to follow into a parking space, as happens when the parking space is in a congested area, backing a vehicle into a space requires the vehicle be maneuvered around objects “in the way.”

When a vehicle is steered or maneuvered around obstacles in either direction, i.e., forward or backward, the vehicle's path will of course have at least one curve, simply because it is not possible for a steered vehicle's movement around an object to be discontinuous. A vehicle cannot be simply lifted off the ground, rotated and lowered back down. A steered vehicle's path forward or backward around an object will therefore always be continuous and include one or more curved segments. Stated another way, a non-linear path of a steered vehicle around an object will always have some curvature, somewhere along the length of the path. A steered vehicle's path around objects can thus have both linear and curving segments.

### Spline Curves

Backing a vehicle into a parking space can be assisted by informing a vehicle's driver, or an autonomous driving system for the vehicle, when and how far to adjust the vehicle's steering wheel or steering mechanism as the vehicle moves so that the vehicle will follow a smooth, curving line from a starting location backward toward and into a desired ending location and that will route the vehicle around obstacles the driver cannot see.

Shapes, including geometric shapes, are considered herein to be any structure, open or closed, having a definite shape and properties, made up of lines, curves and points. Some of the known geometric shapes are square, rectangle, circle, cone, cylinder, sphere, etc. All these shapes have specific properties that make them unique and different from the other shapes Shape thus includes figures closed by a boundary which is made by combining curves, points, and line segments. Each shape has a unique name such as circle, square, triangle, rectangle,

The shapes of mathematical ellipses, parabolas, sines and catenaries are smooth curving lines. They cannot always be perfect mathematical functions, i.e., well-shaped, per se when they are used to model or represent a path or route for a vehicle to follow around an obstacle, partly because none of them have inflection points, i.e., a direction change, which a vehicle is frequently required to do in order to get around an object because of a vehicle's physical characteristics. A third or higher-order polynomial equation can define a smooth, curving line with direction changes/inflection points, but few vehicle parking paths will conform to the shape of a particular third or higher-order polynomial per se, at least in part because particular coefficients of a third or higher-order polynomial equation that will generate a desired path's shape, are quite difficult to determine. A spline curve, as defined below, is therefore a preferred curve or shape of a path for a vehicle to follow backwardly from a starting location to a desired ending location and avoid obstacles between the starting and ending locations.

As used herein, a mathematical spline curve, also referred to herein interchangeably as a spline curve or simply a spline, is a smoothed and curving line, shaped as needed to define or represent a path for a particular vehicle to follow between two end points of the spline curve and which can wrap around obstacles between those end points. A spline curve can also have one or more inflection points, i.e., points where the curve changes its direction (also a point on a spline where the slope of a line tangent to the spline at that point, changes its polarity) in order to provide a path through or around objects. A spline curve is thus the preferred type of curve to represent a path for a vehicle to follow in order to back the vehicle around obstacles between a starting point to an end point, because it can be virtually any shape.

Merriam Webster's Collegiate Dictionary defines a spline as a function on an interval, which approximates a mathematical function and is composed of pieces of multiple simple functions defined on subintervals, joined at their endpoints with a suitable degree of added smoothness. Stated another way, a spline or spline curve is composed of multiple pieces of different mathematical functions. A smooth curve having virtually any shape can thus be constructed by joining the ends of multiple different functions together, i.e., concatenating the segments of functions, to provide a curve for a vehicle to follow around objects. Straight lines, segments of circles, segments of parabolas, and segments of ellipses can all be defined and represented by corresponding mathematical functions evaluated between two values.

A spline or spline curve is therefore considered herein to be one or more segments of mathematical functions, which can be simple curves, complex curves and line segments, each segment being defined by corresponding mathematical functions, at least two of the functions being different from each other. The segments and their characteristics are selected as needed such that when the segments are concatenated, i.e., joined to each other at their end points, the resultant line will extend between two separated points or locations and go around obstacles that prevent a straight line from extending directly between those same two separated points.

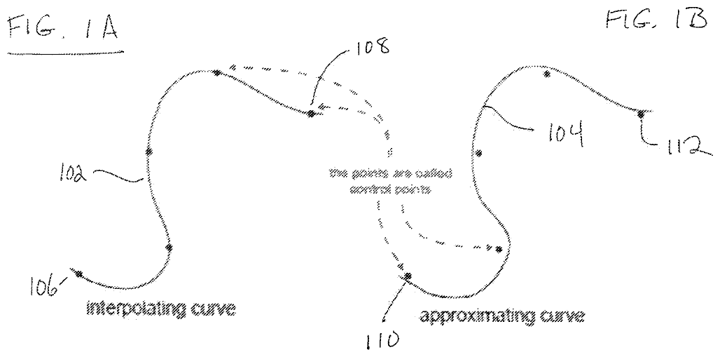

The opposing ends of segments of a spline curve are joined to each other at control points. A spline curve that passes through each control point is called an interpolating curve; a spline curve that passes near but not through control points is called an approximating curve. FIG. 1A depicts an interpolating spline curve 102. FIG. 1B depicts an approximating spline curve 104. Both spline curves 102, 104 have shapes suited to represent a route or path for a vehicle to follow around obstacles that would obstruct a straight line between the curves' end points, 106 and 108 and 110 and 112 respectively.

### Spline Curves in a Constrained Environment on an Occupancy Grid map

A Cartesian coordinate system is well known to be a planar, i.e., two-dimensional coordinate system in a geometric plane in which every point or location in the plane can be specified or identified by a pair of numerical coordinates. A pair of coordinates uniquely identifies a point in the plane relative to two fixed perpendicular (orthogonal) oriented lines measured in the same unit of length. Each reference line in a Cartesian coordinate system is referred to interchangeably as either a coordinate axis or simply an axis of the system. The point where the two orthogonal axes meet is defined as the coordinate system's origin. The numerical coordinates where the two orthogonal axes meet are the well-known ordered pair (0, 0). The coordinates of any point in the plane relative to the ordered pair (0, 0) can therefore be defined by ordered pairs because they define positions of the perpendicular projections of a point onto the two orthogonal axes expressed as signed distances from the origin.

A spherical coordinate system is a well-known three-dimensional coordinate system. Every point in a spherical coordinate system can be identified by a radius or distance from an origin and two angles. Spherical coordinates are commonly known as (r, Φ, θ).

A cylindrical coordinate system is another 3D coordinate system. Every point can be identified by a radius r, an angle θ and z, (r, θ, z). Those of ordinary skill know that the location of any particular point in space can be identified using Cartesian or spherical or cylindrical coordinates.

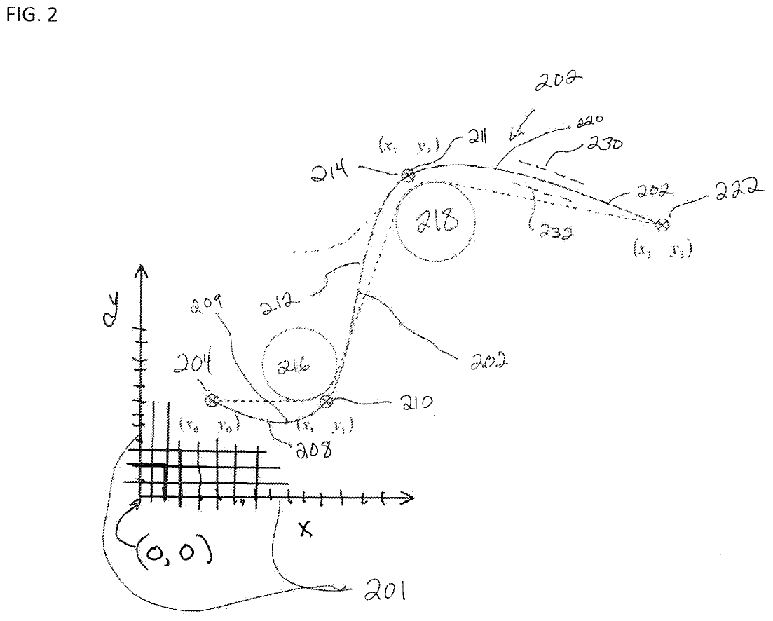

FIG. 2 represents another example of a spline curve 202 the shape of which is somewhat serpentine or boustrophedonic, i.e., alternating in opposite directions, between two end points 204, 222, which are also considered herein to also be spline curve control points. As described below, the spline curve 202 in FIG. 2 is generated (or created) by a mathematically fitting the curve 202 “on top of” a Cartesian coordinate system 201 such that the curve 202 avoids, i.e., extends around obstacles 216 and 218. Reference numerals 209 and 211 identify inflection points.

For illustration purposes, the origin (0, 0) and the perpendicular axes of the coordinate system 201 depicted in FIG. 2 and are located in FIG. 2 at the figure's lower-left corner. The locations of the control points and sequences of geometric points of the spline curve 202 on the coordinate system 201 are located on the system 201 by their respective coordinates.

A first sequence of adjacent geometric points on the Cartesian coordinate system define a first curved line segment 208 extending between the first control point 204 located at x₀, y₀ and a second control point 210 located at x₁, y₁. A second sequence of points define a second curved line segment 212 extending from the second control point 210 to a third control point 214 located at x₂, y2. The first spline curve 202 segment (curved line segments 208 plus 212) between the first control point 204 through the second control point 210 to the third control point 214, avoids or “wraps” around an obstacle represented in FIG. 2 by a circle identified by reference numeral 216. A third sequence of points define a third curved line segment 220 extending from the third control point 214 located at x₂, y2 to an end point 222, which is also a fourth control point. FIG. 2 thus represents a spline curve 202 that extends between two end points 204, 222 located at corresponding Cartesian coordinates x₀, y₀ and x₃, y₃ on a geometric plane, but which also goes around or avoids two obstacles 216, 218, which are located at their own corresponding coordinates, x₁, y₁ and x₂, y2 on the same geometric plane, or spherical or cylindrical coordinates in alternate embodiments.

In the preferred embodiment, a spline curve representation of a path that a vehicle can follow in order to safely avoid objects in a constrained environment comprises steps that include: 1) mathematically generating circles of varying diameters, or mathematically generating shapes of other mathematical functions, on an occupancy grid map representation of the constrained environment and overlaying, i.e., mathematically superimposing, the generated circles and other mathematical functions onto a Cartesian coordinate map, conceptually above or beneath the constrained environment; 2) mathematically constructing a path on the Cartesian coordinate map, that will extend at least part way between a vehicle's “current” location on the Cartesian coordinate map to a desired ending location on the map by joining or concatenating selected segments of generated circles of possibly different diameters, at end points of the selected segments; and 3) joining end points of selected segments of generated circles on the Cartesian coordinate system map with segments of other functions such that when the segments are joined and “superimposed” onto the Cartesian coordinate system, they form a smoothed, curving line is formed on the Cartesian coordinate system map extends between the vehicle's current location and a desired ending or final location on the map, which if followed by the vehicle, the vehicle will travel from its current location on the map to a desired ending location on the map without a collision.

As used herein, the term loading dock refers to an individual platform to which a truck or other vehicle connects to or with, in order to load or unload the truck or other vehicle. Loading bay refers to an indoor or outdoor area having one or more loading docks.

A box truck, also known as a box van, cube van, bob truck or cube truck, is considered herein to be a single-frame truck with an enclosed cuboid-shaped cargo area and a cab. The cargo area and the cab are attached to the same frame. An articulated truck is a truck with a permanent or semi-permanent pivot joint to which a trailer can be pivotally attached, allowing the truck and attached trailer to turn more sharply. Tractor-trailer refers to an articulated truck consisting of a semi-tractor and a trailer, with the trailer pivotally attached to the semi-tractor. The pivot joint of a semi-tractor is known to some in the art as a king pin.

### Backing a Truck Through a Loading bay

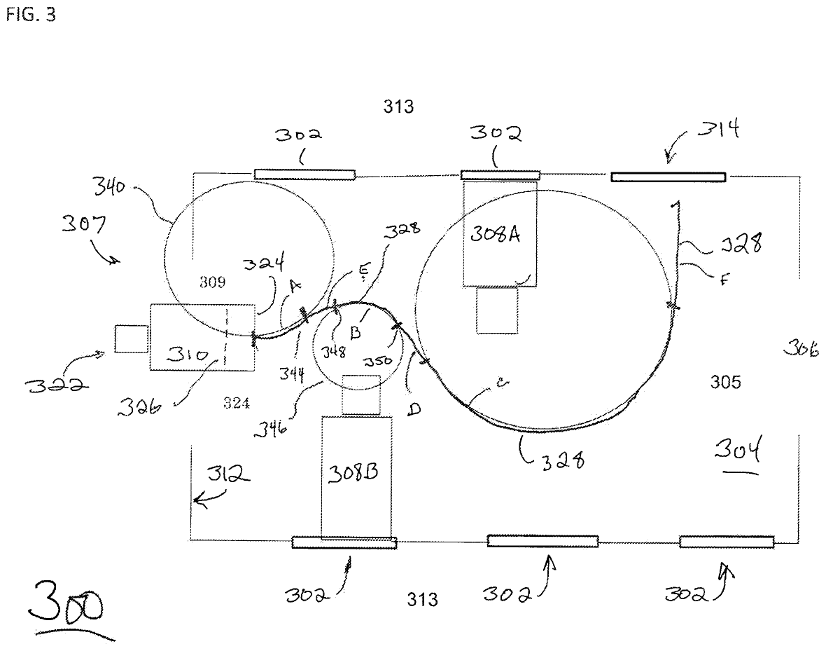

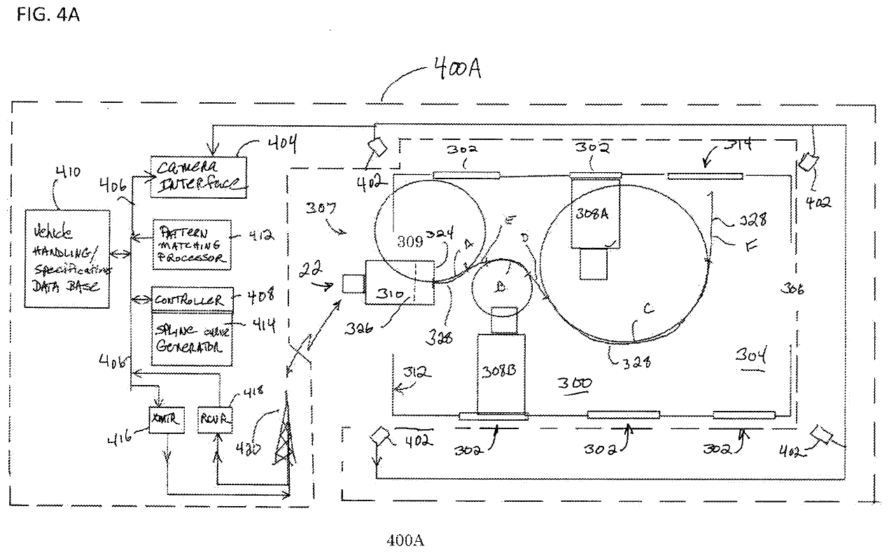

FIG. 3 is a plan or top view of a loading bay 300 having multiple loading docks 302 on opposite sides of a lane 305 having two opposing openings 306 and 307. Vehicles can enter and leave the bay 300 and access loading docks 302 through two openings 306 and 307 at opposite ends 304, 312 of loading bay 300. Two trucks 308A and 308B are shown parked at loading docks 302 on opposite sides 313 of the lane 305.

A truck to be docked 310 at a loading dock 314 in the bay 300 is shown located at a starting or initial location 309 that is near or proximate bay opening 307. The lengths of the particular trucks 308A and 308B, and their extensions into the lane 305, are such that those trucks' extensions into the lane 305 require that the truck 310 follow a curving path 328 around them in order to avoid colliding with them. (One or more different trucks with different extensions parked in the same or different locations might require a differently-shaped path.) The smooth curving path 328 through the bay 300 to back the truck 310 to the loading dock 314 is thus represented a corresponding smooth, curving line 328, i.e., a spline curve, extending from the rear or back end 324 of the truck 310 to the loading dock 314. The spline curve 328 thus has a first or starting location 309 and a second or ending location, which is the dock 314.

For illustration and explanation simplicity purposes, the truck in FIG. 3 to be parked 310 is not articulated, i.e., it is not a trailer coupled to a tractor. The truck 310 has a front end 322 and a rear end 324. The rear end 324 is to be parked against a loading dock 314 near the opposite end 306 of the bay 300. The truck 310 is also represented as having a single rear axle 326.

When the truck is backed through the bay 300 so that the rear end 324 follows (or at least substantially follows) the spline curve 328, the truck's rear end 324 will safely reach the loading dock 314, i.e., the truck 310 will avoid objects in the bay 300 and reach the loading dock 314 without a collision.

The spline curve 328 is generated to have a shape the truck 310 can follow safely to the loading dock 314. The particular shape of the depicted spline curve 328 is responsive to several factors, including the size of and location of the truck 310, its maneuvering characteristics, the size and shape or “footprint” of objects in the bay 300 and their locations and spacing relative to each other, relative to the starting location of the truck 310 and relative to the final or destination that the spline curve 328 must reach.

Vehicle maneuvering characteristics include but are not limited to a vehicle's wheel base, axle count, tire size, turning radius and vehicle width. And as used herein, a turning radius is considered to be one-half of a vehicle's turning diameter. Turning diameter is considered herein as the minimum diameter (or “width”) of available space required for a vehicle to make a circular turn, i.e., a complete, 360-degree “turn”, which the truck will make when the vehicle's steering is rotated to the limit of its travel in either clockwise or counter-clockwise direction.-turn. Turning diameter thus refers to a theoretical minimal circle diameter in which a vehicle can be “turned around,” i.e., turned or rotated by 360 degrees. The tightest turning circle possible for a vehicle is the circle the vehicle follows either forwards or backwards while turning and which effectively simply rotates the vehicle on its own axis.

In the preferred embodiment, a spline curve 328 is generated to have a shape, such that a truck having the particular maneuvering characteristics as the truck 310 to be parked, will go around objects in the bay 300 without collisions when the truck 310 travels backwardly, if the truck travels backward following or at least substantially following the path of the spline curve 328, starting at the curve's starting location 309 up to the curve's ending location, which is the loading dock 314. The method and apparatus disclosed and claimed herein thus refer to determining and providing steering guidance to either a driver or an autonomous driving system required to back (move or drive the vehicle in reverse) so that the vehicle can be safely moved around obstacles backwardly from a first or starting location to a second or final location.

Backing a truck so that the rear end 324 follows or at least substantially follows the spline curve 328, requires the truck's steerable wheels be turned through various angles as the truck is moved backwardly from its starting location 309 to the desired ending location, i.e., the loading dock 314. Steerable wheel movements required to safely move the truck 310 along the spline curve 328 backwardly will vary according to the truck's maneuvering characteristics. The spline curve's shape is therefore generated using (responsive to) maneuvering requirements and steering characteristics of the truck simply because a truck or other vehicle cannot follow a curve having a shape, which the truck or vehicle is physically incapable of following.

### Generating and Fitting a Spline Curve

A constrained environment is considered herein to be a finite area, the sides or perimeter of which is bounded. In an alternate embodiment, a constrained environment can also be a three-dimensional volume. In either embodiment, a vehicle within a constrained environment should be steered or maneuvered within the boundaries of the constrained environment to avoid collisions with objects in the constrained environment, as well as the constrained environment's boundaries.

A constrained environment can include objects and barriers. A constrained environment can also include movable objects such as parked vehicles. Some constrained environments can have objects that move, such as a moving vehicle or a person. A parking lot is an example of a constrained environment. A warehouse is an example of a three-dimensional volume, which can also be a constrained environment. The loading bay 300 of FIG. 3, which is in a parking lot, is a constrained environment. A constrained environment is defined or delimited by a boundary. A boundary is one or more things, which indicate or fix a limit or extent of an area or volume. In FIG. 3, the loading docks 302, 314, the openings 306, 307, the opposite ends 312, 304 and the opposing sides 313, make up a boundary for the loading bay 300 as a constrained environment.

As used herein the term footprint refers to an area or volume occupied by or affected by an object, regardless of whether the object's shape is regular or irregular.

An occupancy grid map is considered herein to be a mapping of the coordinates of locations and coordinates of footprints of objects within a constrained environment onto a Cartesian coordinate system, or spherical or cylindrical coordinates in alternate embodiments, conceptually imposed on, wrapped around or overlaid on the constrained environment. An occupancy grid map is thus one or more sets of (x, y) or Cartesian coordinates (or spherical or cylindrical coordinates) of boundaries or footprints of objects in a constrained environment, sets of (x, y) coordinates of a two-dimensional constrained environment's boundaries also being on the same Cartesian or 3-dimensional rectilinear coordinate system or three-dimensional coordinates. Locations, volumes and footprints of objects in a constrained environment, and the constrained environment boundaries are thus specified by sets of coordinates on a 3D-rectilinear coordinate system.

The size or area of a rectilinear object's footprint requires at least four pairs of coordinates on the Cartesian coordinate system, i.e., a pair of coordinates for each corner of a rectangle. The size or area of a circular object's footprint will require a pair of coordinates for the center of a circle and several pairs of coordinates for several points located on and around the circle's perimeter, the number of which is a design choice. The area of an irregularly-shaped object will also require several pairs of coordinates, depending on the object's shape.

Creating or generating the spline curve is accomplished in part using modified circle packing in that, unlike prior art circle packing, the modified circle packing includes generated circles that can overlap other circles. Using the modified circle packing, segments of circles, regardless of whether the generated circles overlap, can be connected together by segments of other mathematical functions, e.g., ellipses, parabolas, trigonometric functions or hyperbolic trigonometric functions. In the preferred embodiment, a spline curve between a vehicle and a desired destination or location in a constrained environment, is generated by a processor iteratively:
(1) Overlaying, i.e., mathematically superimposing, geometric circles of varying diameters onto the constrained environment's occupancy grid map representation of a constrained environment, each circle having a corresponding radius with at least some of the circles being at least partly within the constrained environment; and
(2) Mathematically concatenating, i.e., mathematically joining together, opposing ends of segments overlaid circles and segments of other mathematical functions, which when they are connected, they form at least part of a smooth, curving line that extends from a first or starting location to, or least part way toward, a second or desired final or ending location, and which avoids obstacles in the constrained environment and provides sufficient side-to-side margins (separation space on each side) also sometimes referred to as a “cost map” or “swept path” for the particular vehicle or truck to be physically able to safely follow the generated line through the constrained environment; or alternatively
(3) In instances when overlaid circle segments are too far apart to be connected directly to each other without introducing unnecessary inflection points or unacceptable curvatures but nevertheless require joining, segments of other mathematical functions are used to join circle segments the result of which is nevertheless a spline curve, such as the spline curve 202 depicted in FIG. 2.

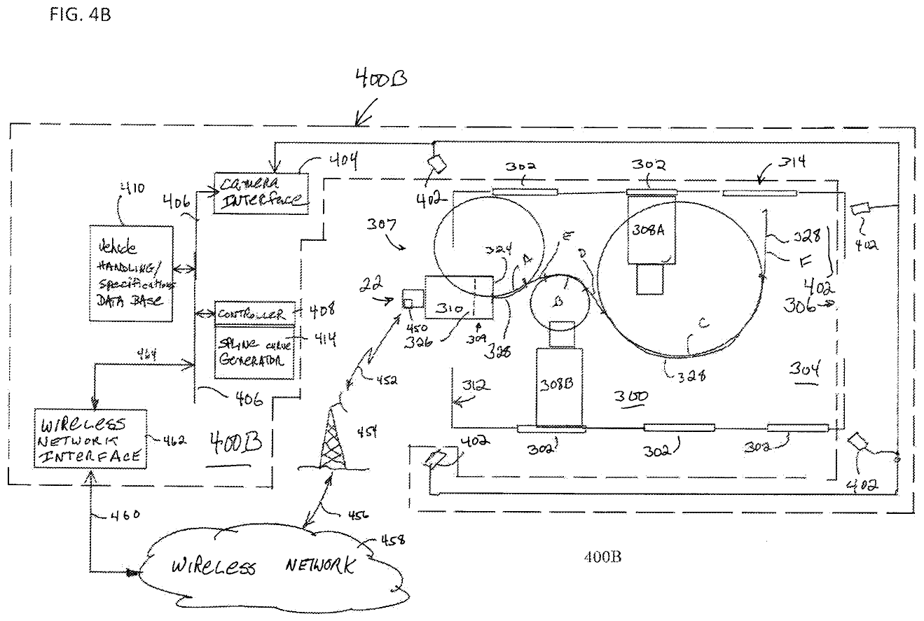

In FIG. 3, FIGS. 4A and 4B, the spline curves 328 comprise segments of overlaid circles the ends of which are joined by what appear to be straight or substantially straight lines but which could also be short segments of other functions such as functions for circles, parabolas, trigonometric functions, hyperbolic trigonometric functions, exponential functions, ellipses or straight lines, all of which are of course mathematical functions. Regardless of their precise nature, their concatenated segments form a smooth, curving line 328, which goes around objects as it extends from a first or starting location to or least part way to a second or desired final or ending location and provides sufficient side-to-side margins (separation space on each side) for the particular vehicle or truck to be physically able to safely follow the generated line through the constrained environment.

In FIG. 3, reference letter “A” identifies a segment of a first circle 340, the end points of which are identified by reference numerals 342 and 344. Reference letter “B” identifies a different segment of a different, second circle 346, the end points of which are identified by reference numerals 348 and 350.

The diameters of the two circles 340 and 346 are different. Their different diameters, and corresponding radii, allow particular segments of those circles to be identified as part of a path around the truck identified by reference numeral 308B when those two segments are joined by an intermediary segment, “E”.

The end point 344 of the first segment A of the first circle 340 is joined or connected to the closest end point 348 of the segment B of the second circle 348 by a “line” segment identified by reference letter “E”. A particular mathematical function that defines the shape of segment “E” in FIG. 3 is not discernible to the naked eye simply because end points 344 and 348 in FIG. 3 are too close to each other to permit visual identification of the particular shape of the segment as being generated by a particular mathematical function. Stated another way, it is not possible to discern from FIG. 3 whether the mathematical function represented by segment “E” is a circle, ellipse, parabola, straight line a third or higher-order polynomial, simply because segment “E” is too short to identify.

Commonly used terms like, “margin” “cost map” and “swept path” refer to the space on one or both sides of a generated spline curve, that a particular vehicle with its particular maneuvering and physical characteristics needs to be able to safely, i.e., without collision, move through a constrained environment. In FIG. 2, reference numerals 230 and 232 represent margin boundaries for spline curve 202. In FIG. 3, discernable margin boundaries of spline curve 328 are omitted for illustration clarity purposes.

The spline curve (or other smoothened and curving line) and required margins are generated by a controller or processor that receives real-time images of a confined area, i.e., a constrained environment from cameras directed into the constrained environment and objects therein, including a truck to be backed from a first location to a second location. Fixed objects in the constrained environment, their Cartesian coordinate locations and sizes, are identified by pattern matching captured images of them, to reference images stored in a database or by providing physical location and characteristics information to the processor. Vehicles for example can provide their Cartesian coordinate locations, their physical and maneuvering characteristics to the processor via an appropriate wireless network extending between at least the constrained environment and the processor. In either case, maneuvering requirements and steering characteristics of a vehicle are also provided to the processor.

After the processor receives or is provided Cartesian coordinate data for the constrained environment and real-time data for vehicles and obstacles in the constrained environment, a smoothened curve (with required margins) is generated to route a vehicle through the constrained environment and avoid or avoid objects in the constrained environment which would obstruct a vehicle moving from its first location to a desired second location.

As used herein, “display device” refers to any device that can display images in two dimensions. Examples of a display device include computer display devices, LCD, LED and plasma screen televisions and a cathode ray tube (CRT) which is also a display device.

In the preferred embodiment, after a spline curve through the constrained environment for the vehicle to follow is generated, data from which a real-time graphical representation of the constrained environment and the generated spline curve can be presented on an in-vehicle display device, is wirelessly transmitted to the truck where it is received and processed for display to the driver in real time. In an alternate embodiment, after a spline curve through the constrained environment is generated, data by which a steering mechanism of an autonomous vehicle can be controlled to maneuver the vehicle through the constrained environment is wirelessly transmitted to the truck where it is received and provided to the vehicle's steering mechanism as steering guidance data.

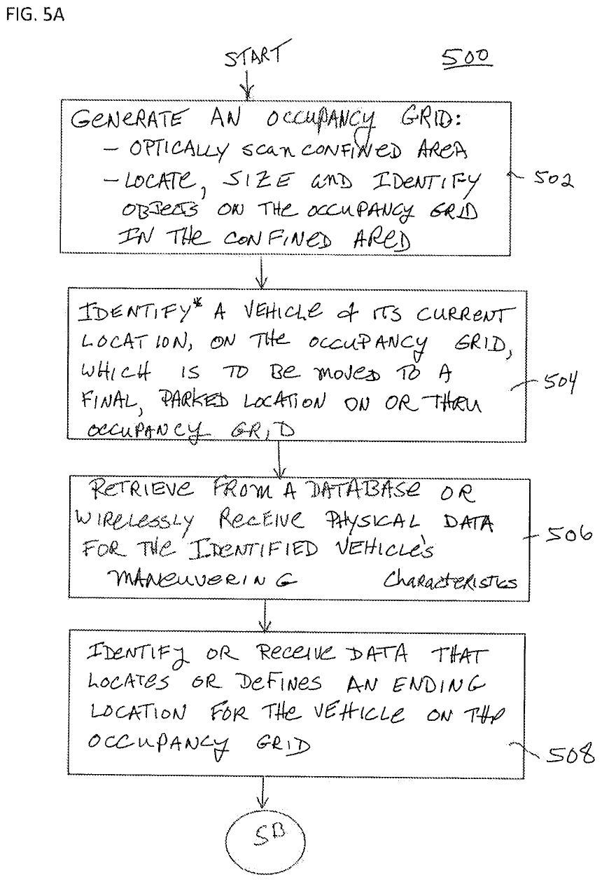

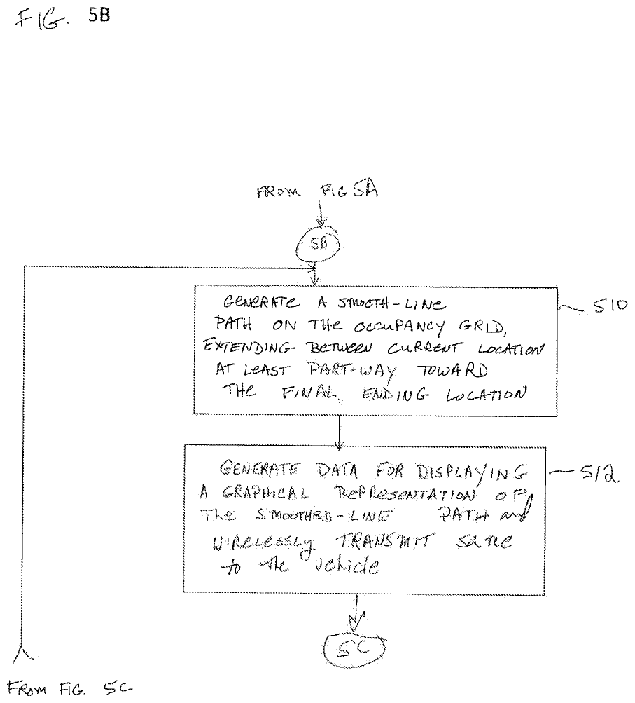

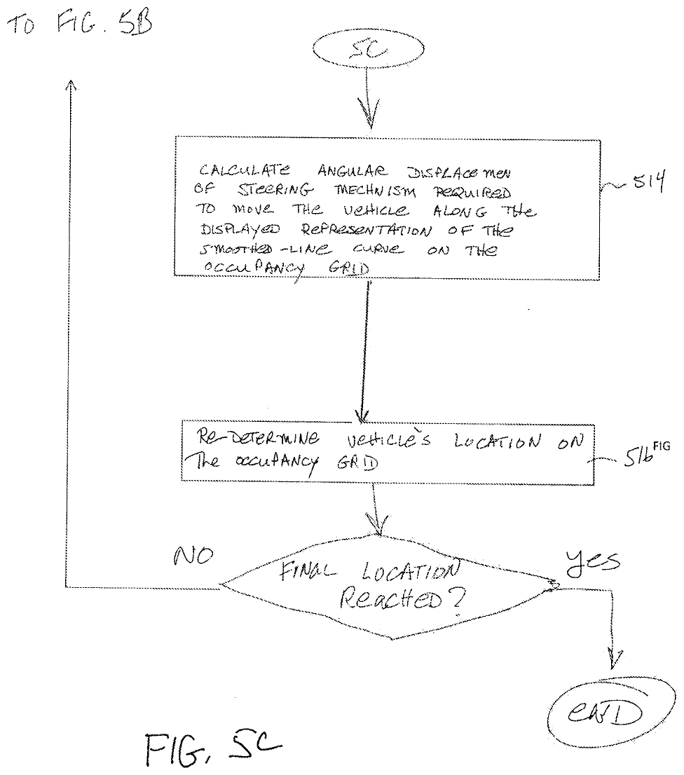

FIG. 4A depicts a first embodiment of an apparatus 400A for providing steering guidance or in an alternate embodiment, generating images on a vehicle-located display device, by which a vehicle can be safely driven backward through a constrained environment. FIGS. 5A, 5B and 5C show steps of a method for providing steering guidance required to move a vehicle through a constrained environment from a starting location toward a final or ending location.

In FIG. 4A, digital cameras 402, which are preferably high resolution (HD “1080p” or better) and preferably stereoscopic, are coupled to an address/data/control bus 406 of a processor, also known as a controller 408 as shown in the figure, which controls the cameras to capture images of objects in the constrained environment embodied as the loading bay 300. The digital images captured by the camera 402 include information by which the relative size, footprint and location of objects in the loading bay 300 can be derived by the processor 408 and specified by their Cartesian coordinates in the constrained environment/loading bay 300. Stated another way, the information from the digital cameras 402 and which is obtained by the processor 408, provide an occupancy grid map of the constrained environment/loading bay 300 and its contents by digitally scanning the loading bay 300 and locating, sizing and identifying objects in the loading bay 300 onto an occupancy grid map that is conceptually overlaid the loading bay 300, such as the Cartesian coordinate system shown in FIG. 2.

Still referring to FIG. 4A, the apparatus 400A also comprises a pattern matching processor 412, which is operatively coupled to a vehicle handling and specifications data base 410 via the system bus 406. The database 410 stores digital representations of images of known vehicles. The database also stores 3D models of vehicles and 3D models of objects in a constrained environment.

By way of example, in the preferred embodiment, the data base 412 stores, front views, back views, left and right-side views, top-views and perspective or isometric views of vehicles, i.e., automobiles, box trucks and articulated trucks typically as well as front views, back views, left and right side views, top-views and perspective or isometric views of trailers that can be coupled to a tractor and which form an articulated, tractor-trailer combination. The preferred embodiment of the data base 410 also stores vehicle maneuvering-related data, which typically comprises wheelbase, wheel diameter, tire diameters, turning diameter/radius, vehicle size, wheel tread width, axle count, side clearance requirements, i.e., margin size, king pin locations and the like.

Pattern matching per se is well known to those of ordinary skill in the art. In the preferred embodiment, a vehicle 310 in the bay/constrained environment 300 is identified by comparing images of the vehicle 310 captured by the cameras 402, to corresponding images of vehicles stored in the database 410. The make, model, size, shape and maneuvering characteristics of the vehicle 310 are thus identified by the pattern matching processor 412 matching camera-captured images to images stored in the vehicle handling and specifications database 410.

By identifying a vehicle, its maneuvering characteristics and physical characteristics such as lateral spacing requirements or margins required by the identified vehicle and which are necessary for it to safely move through the bay 300 are obtained from the data base 410. The location of the identified vehicle 310 and its footprint are thereafter mapped to Cartesian coordinates in the bay 300. The identity, locations and characteristics of other objects in the bay/constrained environment, e.g., the parked trucks 308A and 308B, are determined and mapped onto the same Cartesian coordinate system by their Cartesian coordinates using digital image capture and pattern matching,

After the vehicle 310 and objects surrounding it in the bay/constrained environment 300 are identified, a spline curve is generated by the spline curve generator 414, which in the preferred embodiment is set of program instructions for the controller 408. Those instructions cause the controller 408 or other processor to iteratively perform the steps described above and as those steps are shown in FIGS. 5A-5C.

As used herein, “real time” refers to the actual time during which something takes place. In the preferred embodiment, the method of generating a spline curve to go around objects in the constrained environment is repeated iteratively as the vehicle 310 moves toward a destination such that the shape of the generated spline can change in real time (or substantially real time) in response to changes in the vehicle's location caused by a driver or autonomous-vehicle steering anomalies or aberrations, or as objects in the constrained environment might change or as the system-determined location of the vehicle 310 or the system-determined footprints of objects in the constrained environment might change.

Still referring to FIG. 4A information, i.e., digital data, representing coordinates of the generated spline curve's shape, are provided by the controller 408 to a radio frequency transmitter 416 via the same bus 406 that connects all of the different system components together. The information representing the generated spline curve's shape is thereafter broadcast from an antenna 420 into the loading bay/constrained environment 300. That information is then provided to either the vehicle's autonomous driving system (not shown) or to an in-vehicle display device/user interface (not shown) by which the vehicle can either steer itself backwardly to the loading dock 314 or instructions or images can be provided to a driver by which the drive can safely back the vehicle along a spline curve to the loading dock 314.

The system in FIG. 4A thus wirelessly broadcasts data into a constrained environment from which representations of necessary steering guidance can be provided to the vehicle and by which a vehicle's movement will substantially conform to a smoothed curving line path's shape required to move the vehicle toward the final ending location.

FIG. 4B depicts a second and alternate embodiment of an apparatus 400B for providing steering guidance, or in an alternate embodiment, generating images on a vehicle-located display device and by which a vehicle can be safely driven backward through a constrained environment. FIGS. 5A, 5B and 5C show the steps of a method for providing steering guidance required to move a vehicle through a constrained environment from a starting location toward a final or ending location.

The embodiment shown in FIG. 4B includes the high-resolution (preferred but not essential) digital cameras 402 shown in FIG. 4A. The digital cameras 402 are also coupled to the address/data/control bus 406 of the processor 408, which controls the cameras to capture images of objects in the constrained environment embodied as the loading bay 300. The digital images captured by the cameras 402 include information by which the relative size, footprint and location of objects in the loading bay 300 can be derived by the processor 408 and specified by their Cartesian coordinates in the constrained environment/loading bay 300, and which enables 3D models of those objects to be created. Stated another way, the information from the digital cameras 402 and which is obtained by the processor 408, provide an occupancy grid map of the constrained environment/loading bay 300 and its contents by digitally scanning the loading bay 300 and locating, sizing and identifying objects in the loading bay 300 onto an occupancy grid map that is conceptually “beneath” the loading bay 300, such as the Cartesian coordinate system shown in FIG. 2.

Instead of identifying vehicles by pattern matching, the system of FIG. 4B receives vehicle handling and maneuvering data from the vehicle requesting backing assistance rather than by pattern matching. The system of FIG. 4B thus comprises a wireless network interface 462, which is operatively coupled to a vehicle 310 requiring backing assistance through a wireless communications network 458 that is linked or coupled to the vehicle 310 by a wireless communications link 452 extending between the vehicle 310 and the wireless telecommunications network 458.

A bus 464 extends from the wireless network interface 462 to the system bus 406. Information/data obtained or received from a radio 450 in a vehicle 310 in the loading bay 300 is thus provided to the system bus 406 using the wireless network 458 rather than being determined from pattern matching and a database.

Maneuvering characteristics and physical characteristics information that pertain to truck 310 are sent “directly” to the controller 408 and spline curve generator 414, expediting the creation of spline curves. The vehicle's 310 maneuvering and physical characteristics can be stored within radio 450, which is part of the truck 310.

After a spline curve is generated by the spline curve generator 414, data from which a generated spline curve can be viewed on a display device located in the truck 310 is wirelessly “sent” back to the truck 310, i.e., transmitted or broadcast into the constrained environment, through the wireless network.

For claim construction purposes, the wireless network 458 in FIG. 4B can be a prior art cellular telephone network. In such an embodiment, the radio 450 in the vehicle 310 and the wireless network interface are of course “cellular” devices. The transmission of image data sent to the truck 310 by the cellular network interface 462 and the spline curve generator 414, is thus considered herein as causing or effecting the wireless data broadcast performed by the cellular network, which is of course a wireless communications network.

Those of ordinary skill in the art should recognize that the radio communications depicted in FIG. 4B can also be readily provided by other wireless communications systems. Such systems can include WI-FI but they also include Specialized Mobile Radio systems or SMRs, which are well-known to those of ordinary skill in the art. Bluetooth is a wireless communications protocol that could also be used.

For claim construction purposes, communications networks, wireless communications networks and the like, should be construed to include WI-FI, cellular networks as well as SMRs authorized by F.C.C. Rule 47 C.F.R., Part 90, which is incorporated herein by reference and Bluetooth. Such systems are well known to those or ordinary skill in the two-way radio systems art. The interface 462 and spline curve generator 414 and equivalents thereof thus cause or effectuate a wireless data broadcast into a constrained environment through or via a wireless communications network.

The embodiment of FIG. 4B avoids misidentifying a vehicle using pattern matching required by the embodiments shown in FIG. 4A but at an additional expense and additional complexity. More particularly, the embodiment shown in FIG. 4B requires the truck 310 to be equipped with wireless communications equipment, which can establish a two-way or bi-directional data connection to the wireless communications network interface 462 via the wireless communications network 458.

The system in FIG. 4B thus provides data into a constrained environment and from which representations of necessary steering guidance can be provided to the vehicle and by which a vehicle's movement will substantially conform to a smoothed curving line path's shape required to move the vehicle toward the final ending location. Unlike the system of FIG. 4A, in FIG. 4B, the data is wirelessly broadcast into the constrained environment by a cellular carrier.

The word “successive” ordinarily means following in order; or following each other without interruption. As used herein, however, “successive” should be construed more broadly. “Successive” should be construed to include events or images that follow each other in order and but “successive also includes events or images that occur, or which are captured, not immediately following each other but which may not immediately follow each other. By way of example, first, second and third images captured by a digital camera are considered “successive,” however, the first and third captured images are also considered herein as being “successive.” Captured successive images need not be “immediately following, one after the other.”

FIGS. 5A-5C, depict steps of a method 500 by which a spline curve is generated for an identified vehicle needing to be backed into a parking space in a constrained environment. As stated above, the shape of the generated spline is “tailored” to accommodate the physical and maneuvering characteristics of the particular identified vehicle, which is to be safely moved backwardly through the constrained environment from an initial location to a desired destination. The generated spline curve's shape is also “tailored” to objects in the constrained environment. In that regard, a generated spline curve might or might not have inflection points, i.e., control points and substantially straight segments that depict where a particular vehicle in a particular constrained environment might have to move forward and backward repetitively with relatively small angular displacements between successive movements in order for the vehicle to be turned or “pointed” toward a desired ending location.

In FIGS. 3 and 4, the end points of circle segments A, B and C are joined together by what appear to be substantially straight lines, which are identified by reference letters D, E and F. Segments D, E and Fare short. Because the lines D, E and F are short, they cannot be identified with particularly but could be segments of mathematical functions for one or more of a straight line, a parabola or an ellipse, as long as segments D, E and F properly link segments A, B and C to form a mathematical spline.

Referring now to FIG. 5A, in step 502, an occupancy grid map for a confined constrained environment is generated from digital images of the constrained environment as described above. In an alternative embodiment, an occupancy grid map can be generated using 2 or 3-dimensional, mathematical models of objects in the constrained environment, which could itself also be a mathematical model. Models of objects are often used in computer aided design (CAD) systems.

In step 504, a vehicle to be moved through the constrained environment and its current location and which is to be moved, e.g., backed, to a second or desired location is identified as described above. Its location in the constrained environment is also mapped onto the occupancy grip map.

In step 506, physical and maneuvering characteristics for the identified vehicle are retrieved from a database as described above. In an alternate environment, however, those physical and maneuvering characteristics are provided by the vehicle itself to a controller or processor that will generate a spline curve through the constrained environment for the vehicle.

In step 508, a starting and ending location for the vehicle is identified using Cartesian coordinates of the identified vehicle's current location, i.e., its location at the time that digital images of the vehicle are captured, relative to a desired ending location, which is also identified by its Cartesian coordinates on the occupancy grid map.

As stated above, a mathematical spline curve is formed by connecting together segments of mathematical functions. The size and shape of the spline, however, needs to extend around objects between the identified vehicle and the desired ending location such that the spline's shape will also provide margins for the identified vehicle.

Curved sections of a spline curve will of course have radii. The radii of the curved sections correspond to the identified vehicle's turning diameter as well as the side margins required by the identified vehicle. Stated another way, the curved sections of the spline curve should have radii of curvature not less than one-half the turning diameter of the identified vehicle. Such a radius of curvature assures the identified vehicle will be able to follow the spline around obstacles in the constrained environment.

In step 510, mathematical representations of circles, ellipses, lines, and segments thereof (i.e., segments of circles, ellipses, lines) are “generated” by the spline curve generator 414. The number of circles ellipses, lines, and segments thereof that are generated and their corresponding diameters, are iteratively changed incrementally by the spline curve generator 414 until the generator 414 effectively determines by experimentation, a number of segments of circles ellipses, lines of various lengths, having possibly the same or different curvature radii, will form a smooth, curved and continuous line, i.e., a spline curve, between the location where the vehicle is currently located and a desired ending location and which will go around obstacles in the constrained environment.

As noted above, the curves in the generated spline curve should have a minimum radius of curvature not less than ½ the identified vehicle's turning diameter. The generated spline curve should also have space or margins on both sides of the spline curve along its length, wide enough for the identified vehicle to safely pass between other objects in the constrained environment which are alongside the generated spline curve. Stated another way, if the identified vehicle follows the spline curve, its margins will be sufficiently wide to allow the identified vehicle to back into the desired ending location without colliding an object in the constrained environment.

A spline curve path for backing a vehicle through a particular constrained environment might require one or more straight line segments in combination with one or more curving segments in order to generate a spline curve without discontinuities between the starting and ending locations. As shown in FIG. 3, the identified vehicle's starting location, spline control points and the vehicle's starting and ending points are mapped onto a Cartesian coordinate system, i.e., the occupancy grid map, for the constrained environment, regardless of whether the spline curve segments are straight or curved.

Referring to FIG. 5B, at step 512, data that represents the Cartesian coordinates of the beginning and end of the spline curve and the spline curve control points is wirelessly broadcast into the constrained environment where it can be received by the vehicle to be parked.

At step 514 in FIG. 5C, in a first embodiment, data representing the spline curve on the occupancy grip map is provided to an autonomous driving system. Angular displacements required of the vehicle's steering mechanism that are required to cause the vehicle to “back over” the path of the generated spline curve on the occupancy grid map, are calculated and continuously updated such that the vehicle follows a path that is the same as or is at least substantially the same as the generated spline curve.

In a second embodiment, data representing the spline curve on the occupancy grip map is provided to a user interface, such as a display screen, on which icons or symbols are displayed that inform a driver a direction and amount by which the vehicle's steering wheel should be rotated to “back over” the path of the generated spline curve on the occupancy grid.

At step 516, after the vehicle has moved, the vehicle's location is redetermined. In the preferred embodiment, the spline curve's shape is thereafter iteratively changed by re-calculation as the vehicle moves forwardly or backwardly and then re-sent to the vehicle to assure the vehicle's adherence to a path that will route the vehicle safely to the desired destination. Changing the spline curve's shape iteratively should be construed as including changing the spline curve's shape continuously as well as changing its shape substantially continuously.

The preferred embodiment of the apparatus shown in FIG. 3 generates spline curves that can be either interpolating curves or approximating spline curves. Both types of curves can have inflection points, which are considered herein to be points with x, y coordinates where the polarity or direction of the spline curve's slope changes. Stated another way, an inflection point is a point where the spline curve's direction changes.

### Displaying a Vehicle's Movement in a Constrained Environment

Three-dimensional or “3D” modeling is a process of developing a mathematical, coordinate-based representation of a surface or volume of an object in three dimensions using specialized software by manipulating edges, vertices, and polygons in a simulated 3D space. Three-dimensional (3D) models represent a physical body using a collection of points in 3D space, each point being defined or located by coordinates, which are preferably Cartesian coordinates but may also be spherical coordinates or cylindrical coordinates. Edges, vertices and/or polygons may be “connected” to each other by geometric entities such as triangles, lines and curved surfaces etc., also defined by coordinates. Since a 3D model is a set or collection of data points and other information, 3D models can be created manually, algorithmically, procedural modeling and/or by scanning and changing respective coordinates. And, their surfaces may be defined to have texture and color by adding or changing coordinates.

A three-dimensional model of an object can be viewed in two dimensions, e.g., on a computer display device, by converting the three-dimensional model of an object into two-dimensional images. As used herein “render” and “rendering” refer to any process by which (X, Y, Z) data representing a three-dimensional model of an object is converted into two-dimensional images. Rendering is thus a process of generating a 2-dimensional image or a 2-dimensional animation from a 3D model or scene.

Rendering involves calculating how light interacts with objects, materials, and surfaces to create a realistic visual representation. Video of a 3D model can be created and displayed on a display device by successively displaying two-dimensional images, (considered herein as frames of video or video frames) each of which may be created by rendering a three-dimensional model of an object or rendering a video frame or rendering a portion of a video frame.

3D models of different objects can be combined or added. 3D models of different objects and surfaces “around” objects can also be combined. The mathematical manipulation of a 3D model, the rendering of the manipulated model and the display of a two-dimensional image of the rendered, manipulated model enables the display of a vehicle's movement in a constrained environment. Stated another way, when a 3D model of a vehicle is added or combined with a 3D model of a constrained environment, the manipulation of those two models and the subsequent rendering and display of the manipulated 3D models provides a two-dimensional image of the 3D models of the constrained environment and anything therein. Successive manipulations of the 3D models, successive rendering of every manipulation and the display of those rendered 3D images, effectively provide real-time video of a vehicle's movement in a constrained environment.

Model-generation software based on special coordinate systems are well known in the engineering community. The 3D model files created, used, and manipulated by 3D modelling programs are known by various different names, including but not limited to ISO 10303, STP File and P21-File. (FBX, OBJ, Step, etc.). Such tools allow users to create, modify, and visualize two and three-dimensional objects, as well as create mathematical models for motion analysis, dynamics, simulations, etc. on a display device, such as a laptop computer display screen. A 3D model of an object and a 3D model of a surface may be “transformed” by 3D modelling programs to simulate how or what a person would view the object or surface from different locations relative to the simulated object or surface. There are two ways a 3D model can be transformed.

An object transformation alters the coordinates of each point according to some rule, leaving the underlying coordinate system unchanged. A coordinate transformation produces a different coordinate system then represents all original points in the new coordinate system.

By way of example, a 3D modelling program can transform or manipulate a 3D model of an object to simulate how the object would look to an observer who is outside the object. A 3D modelling program can also transform or manipulate a 3D model of the same object to simulate how the object would look to or how it would appear to an observer who is inside the object.

The view of an object taken from its exterior is commonly known as a third-person view. The view of an object taken from inside the object is commonly known as a first-person view.

Rendering programs are well-known to those of ordinary skill in the computer game art. In one embodiment, calculating or rendering 3D-models of a constrained environment and a vehicle in the constrained environment into 2D images, can be performed “remotely” vis-à-vis the vehicle, e.g., by a computer or “server” at a location away from or outside the vehicle. In such an embodiment, wherein rendering is done by a computer or graphics processing unit (GPU) on a “server side” of a system for displaying a vehicle's movement in a constrained environment, the 2D image information is wirelessly transmitted as a radio frequency signal. In an alternate embodiment, calculating or rendering 3D-models of a constrained environment (CE) and a vehicle in the constrained environment into 2D images, can be performed within or at a vehicle equipped with an appropriately programmed and capable general-purpose computer or preferably a GPU, well-known to those or ordinary skill. In such an alternative embodiment, data representing 3D models of a CE and vehicle is wirelessly transmitted to the client. The “client” renders 2D images and displays 2D images on a display device in the vehicle.

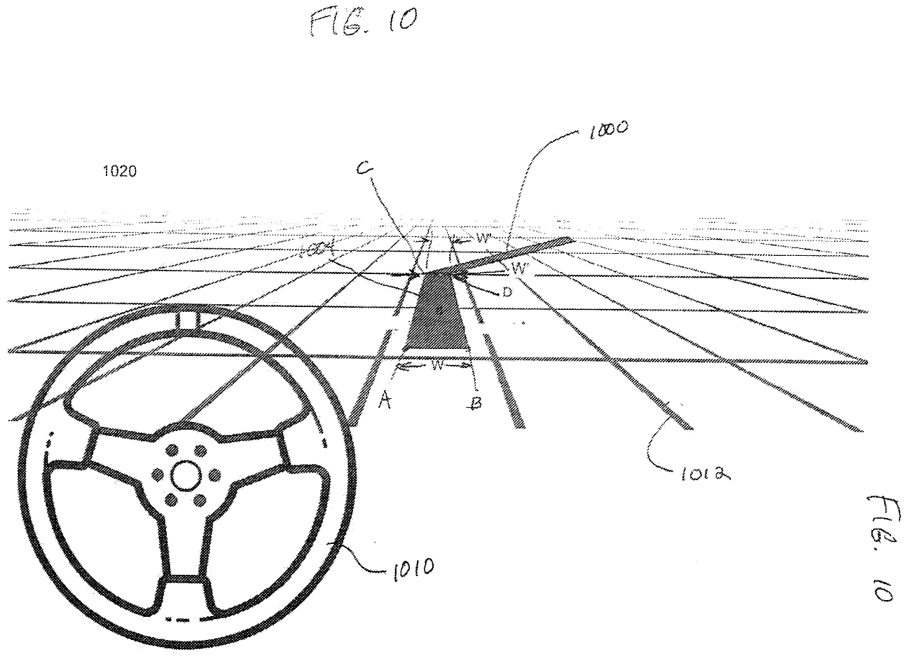

FIG. 9 depicts a display screen 900 of a laptop or tablet computer, which may be inside, attached to, or embedded into the dashboard of a vehicle. The vehicle's dashboard itself is not shown in the figures in interest of brevity because such display screens are nearly ubiquitous in virtually all vehicle types and thus well known to anyone who has been inside a recently manufactured vehicle.

The display screen 900 displays a 2D image of a top view of a “3D model” of a vehicle 902. The image of the vehicle 902 on the screen 900 is thus a 2D simulation of an actual vehicle.

The vehicle 902 is displayed inside a 3D-model of a constrained environment 904 (CE). The view of the CE 904 is thus a simulation of an actual CE.

The 3D-model of the CE 904 also includes 2D images representing simulations of “3D-models” of actual, non-vehicle objects. Such objects in FIG. 9 include streetlights 906A, a fire hydrant 906B and a tree 906C, all of which are shown as 2D images of those objects inside a 2D image simulating a 3D-model of an actual constrained environment CE 904.

The images in FIG. 9 are depicted as being over laid a Cartesian coordinate system grid 1012 having x and y axes. The 2D images of 3D models of the vehicle 902, a constrained environment 904, non-vehicle objects 906A, 906B and 906C and a 3D model of a spline curve 908, is produced by rendering those 3D-models to create 2D representations of each them.

In FIG. 9, the rendered 3D models of objects and surfaces provide a 2-dimensional image of how those objects and surfaces would appear to a person located above the constrained environment 904, above the vehicle 902, above the non-vehicle objects 906A, 906B and 906C and above the spline curve 908. Those of ordinary skill in the computer gaming art often refer to such a view as a third-person view. A third-person view may thus be the view of a person outside a vehicle but inside the constrained environment. A third-person view may also be the view of a person outside the vehicle and outside the constrained environment.

As used herein, a first-person view is the view of an object that a person inside a vehicle would see. In that regard, FIG. 10 depicts a 2-dimensional image representing a 3D model of a spline curve 1000, which a person would see when he or she looks through the windshield of a vehicle (not shown). FIG. 10 is thus a first-person view.

A trapezoid-shaped “first portion” 1004 of the spline curve 1000 is “over-laid” a Cartesian coordinate system grid 1012. The first portion 1004 has four corners identified by reference letters A, B, C and D. The width, W, of the first portion 1004 and its depth, d, are defined by the (x, y) grid coordinates of the corners/vertices denominated as A, B, C and D. The first portion 1004 “drawn” on the display screen 900 is a trapezoid but it is proportioned and shaped to appear to be a rectangle extending away from an observer, typically a driver seated behind a steering wheel 1010. The trapezoid-shaped first portion appears to be an extended rectangle because the separation distance, W′ between the two distal or “far end” corners C, D of the putative “rectangle” is significantly less than the separation distance, W, between the proximal or “near end” corners A, B. To produce such a visual effect, the 3D model of the first portion 1004 is manipulated (transformed) to reduce W′ relative to W. In one embodiment, x, y grid coordinates of each corner, A, B, C and D, are obtained from the 3D-model of the first portion 1004 and provided to the rendering software. In another embodiment, the 3D model of the first portion 1004 is manipulated and rendered to make the first portion's shape trapezoidal.

As used herein, the term, “to scale” means that displayed sizes of objects and surfaces are processed to be a “correct” size, relative to each other. The sizes of objects and surfaces can thus be scaled up or down in order to make their displayed sizes appear to be larger or smaller relative to other objects and surfaces. Stated another way, the 3D models of a constrained environment, 3D models of objects and 3D models of surfaces “inside” the constrained environment, are all manipulated such that when those 3D models are rendered together on the same display screen, the 2D images of them as displayed, appear to be the correct size relative to each other. For example, the length and width of a tractor-trailer displayed on a screen as being inside the constrained environment, are displayed such that the length and width of the displayed tractor trailer are greater than the displayed length and width of a modelled automobile displayed on a display device as being inside the same constrained environment.

In an embodiment, a user can manipulate 3D models to provide either a first person or third person display of the 3D models when those models are rendered for two-dimensional display. In an embodiment wherein a user can select either a first person or third person view, the display of either a first person or third person view is preceded by corresponding computer-performed manipulations of the 3D models of the CE, the vehicle, the spline curve, any other object or surface to be displayed using a first-person or third-person view. After the 3D models are manipulated to provide either a first-person or third-person view, the manipulated models are rendered for display on a display device then sent to a display device where the 1^{st} person or 3^{rd} person views are provided to a user.

The computations required to perform model manipulation and rendering required for either a 1^{st} person or 3^{rd} person view are not trivial. Providing a video of a simulated vehicle's movement through a simulated constrained environment, in either a high-definition or ultra-high-definition format in real time, which is also acceptably smooth and life-like might be beyond the computation capabilities of currently available tablet computers and “laptop,” i.e., battery-powered “portable” computers. Therefore, the preferred embodiment of a system for selectively displaying the movement of a simulated vehicle through a simulated CE, which can include a simulated spline curve and simulations of other objects and surfaces, in either a 1st person or 3rd person view, preferably comprises one or more computers, each computer preferably equipped with at least one graphics processing unit (GPU). Those one or more computers comprise a “server” for such a system. However, an alternate embodiment of a system for displaying the movement of a simulated vehicle through a simulated CE, which might include a simulated spline curve and simulations of other objects and surfaces, in either a 1st person or 3rd person view, may comprise a “client side” computer such as a tablet or laptop, with or without a GPU, said table or laptop capable of being located within, or physically attached to, or otherwise “part of” a vehicle but wirelessly coupled to a server from which 3D models for a CE, vehicle and spline curve, among other things, can be wirelessly downloaded to a “client side” computer.

Regardless of where the model manipulation and rendering is performed, the ability to selectively display either first person or third person views of vehicle manipulations allows a user to select a view he or she prefers. Such first person or third person model manipulations are preferably rendered and displayed on a display device in a vehicle while the vehicle is stationary, i.e., before an actual vehicle is moved and may include augmentations, such as a spline-curve having a displayed width, which represents the width of a path required for the vehicle to safely travel through a CE. Other augmentations include text, progress bars, waypoints and are collectively considered herein as augmentations overlayed onto the display device to provide the driver of the vehicle more-precise representations of a vehicle and its surroundings. One augmentation is a 3D modeling and rendering of a spline curve path through a CE, the modelled and rendered spline curve having a particular width that a particular vehicle requires in order to safely travel through the CE.

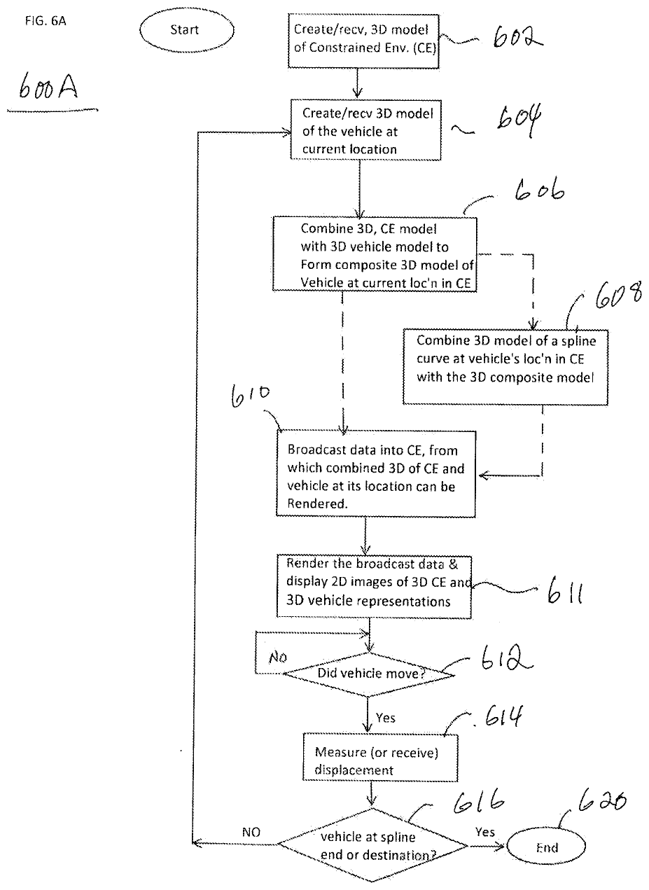

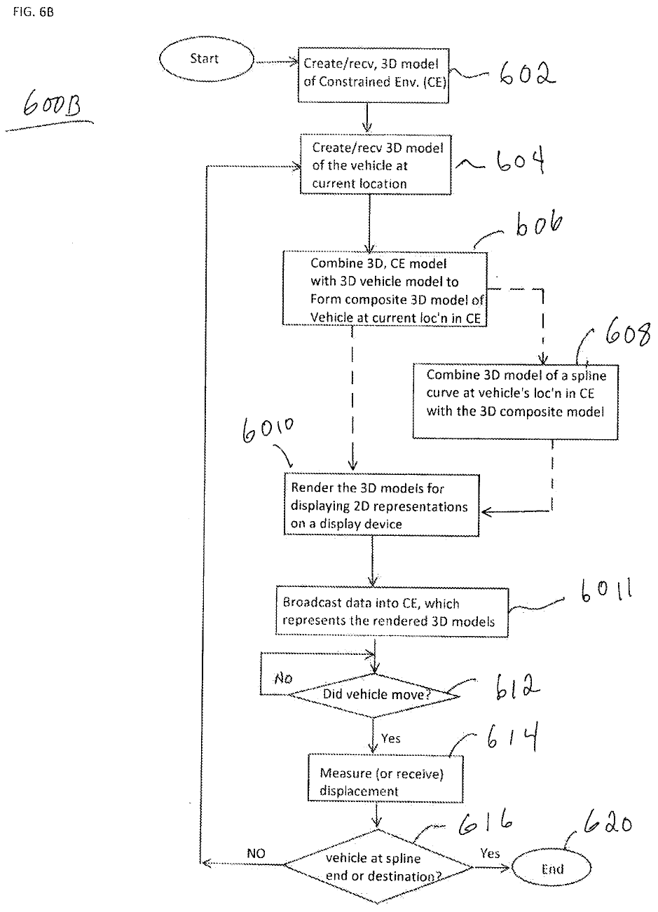

FIG. 6A depicts a method 600A of displaying on a 2D display screen, simulated movement of a simulated vehicle through a simulated constrained environment 904. FIG. 9 is an exemplar of a third-person, top-view of a 2-dimensional representation of a 3D-model of hypothetical constrained environment 904. FIG. 9 is thus a third-person, top-view of a 2D representation of a 3D model of a tractor-trailer 902 and a third-person, top-view of part of a 2D representation of a 3D model of a spline curve 908. Stated another way, when the 3D models of the constrained environment 904 and 3D models of object in the constrained environment model are rendered, 2-dimensional images representing the 3D models can be provided to a display screen to provide a simulation of the vehicle, and a simulation of its movement, through a simulated constrained environment. By manipulating 3D models, different views of the various 3D-modelled objects and surfaces can be seamlessly rendered and displayed.

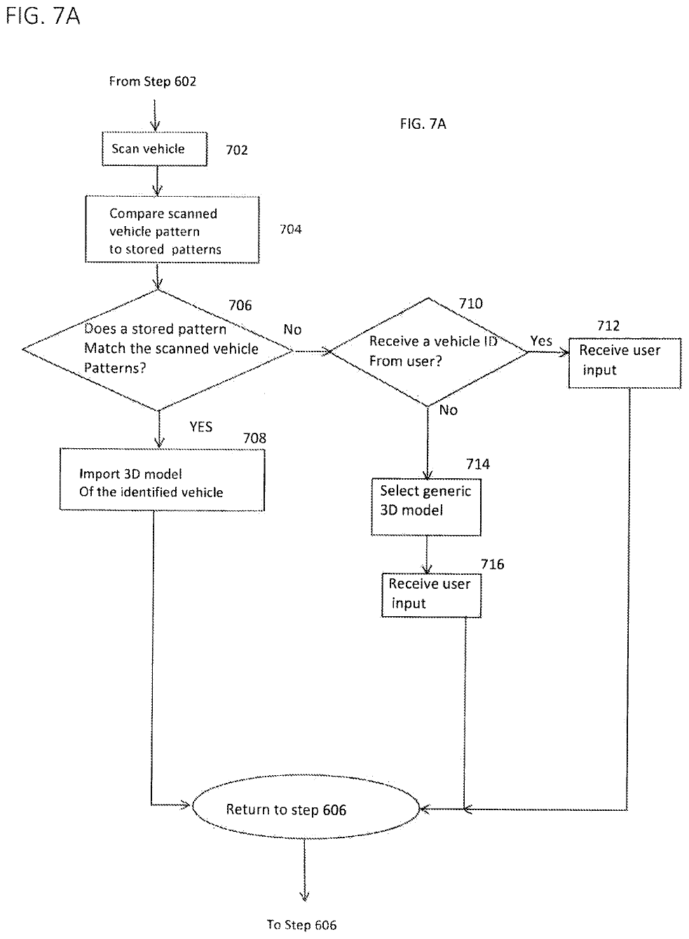

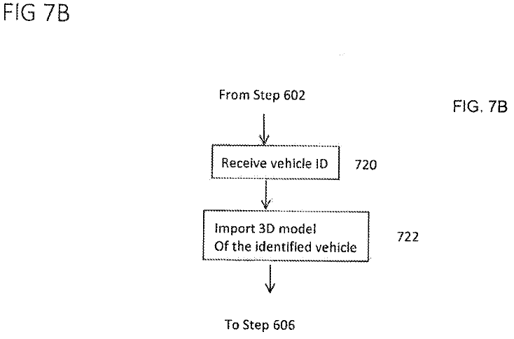

3D models can be created manually, algorithmically, by procedural modeling or scanning. Regardless of how 3D models are created, at step 602, a 3D model of a constrained environment is created. In step 604 of FIG. 6A, a 3D model of a vehicle, at a particular location in the constrained environment is created. FIGS. 7A and 7B depict two different methods of creating 3D vehicle models.

As shown in FIG. 7A, a first step scans physical contours and dimensions of an unknown vehicle, preferably using one or more digital cameras. In that regard, at step 702, one or more digital cameras, such as the digital cameras 402 depicted in FIG. 4, capture digital images or digital video of an unidentified vehicle in the CE. At step 704, an unidentified vehicle is preferably identified by pattern matching, i.e., comparing pre-stored images or video of various known vehicles to images or video of the unknown vehicle captured in step 702.

At step 706, if captured images or video of an unknown vehicle “match” stored images or video of known vehicles, a 3D model of the “identified” vehicle are “imported,” from the database where reference images and videos are kept, for use in subsequent method steps depicted in FIG. 6A. If at step 706, it is determined that a vehicle that entered a constrained environment cannot be identified by pattern matching, in steps 710 and 712, a user can either provide the vehicle's identity manually through any conventional user interface for a computer, or a user can input a 3D model for the unidentified vehicle or select and input (through any conventional user interface) a generic 3D model for the vehicle in steps 714 and 716. A user-provided 3D modelled input at steps 714 and 716 can thus be used in subsequent steps of the method depicted in FIG. 6.

In FIG. 7B, the method steps of FIG. 6A is accomplished more expeditiously and more accurately if the processor performing steps of the methods 600A or 600B receives a vehicle's identity and a vehicle's physical characteristics from a vehicle itself, as happens at step 720 of FIG. 7B. Wireless transmission of the vehicle's identity and physical characteristics can be accomplished using a variety of wireless data transmission protocols such as cellular telephone, WI-FI, Blue Tooth or a text message. Regardless of how the vehicle's identity and characteristics are wirelessly transmitted to and received at a processor, at step 722, a 3D model of the self-identified vehicle is imported to a processor performing method 600A or 600B.

In a preferred embodiment, 3D models can be “scaled” upwardly and downwardly to change the displayed size of a modeled vehicle as well as the displayed size of a modeled constrained environment. Such scaling or re-sizing of a displayed object or surface is commonly referred to as “zooming in” and “zooming out.” Scaling/re-sizing can thus be implemented using 3D model manipulation methods, well known to those of ordinary skill of image processing.

Referring again to FIG. 6A, at step 606, the 3D models of the constrained environment and the vehicle are “combined” to form a “composite” 3D model of both the constrained environment and the vehicle inside the constrained environment. More importantly, the 3D model of the vehicle “combined” with the 3D model of the constrained environment is a 3D model of the vehicle at a particular location in the constrained environment. Step 606 thus accomplishes combining a model of the constrained environment with a model of the vehicle at a first location in the constrained environment to form a composite 3D model of the vehicle at a particular location inside the constrained environment 904.

As stated above, a boundary is one or more things, which indicate or fix a limit or extent. In FIG. 9, a boundary of the constrained environment identified by reference numeral 904 is defined by connected-together straight-line segments and quarter circle arcs, each being identified by the same reference numeral 910 because reference numeral 910 identifies the boundary for the constrained environment 904. Typical boundaries can be a fence, lot line, walls and the like. Boundaries for a constrained environment 904 will typically include physical objects, such as buildings, light poles 906A, fire hydrants 906B and vegetation 906C. In FIG. 3, the loading docs 302, 314, the openings 306, 307, the opposite ends 312, 304 and the opposing sides 313, are things which fix or limit the extent of a loading bay 300 and make up the boundary for the loading bay 300 as a constrained environment. A 3D model of a constrained environment 904 thus preferably includes models of the objects and surfaces, and their locations, inside predetermined boundaries 910. “Predetermined” means of course determined beforehand.

FIG. 9 includes a spline curve 908. When step 606 is completed, the method disclosed in FIG. 6A may include an optional step 608, which combines a 3D model of the spline curve 908 with the 3D composite model of a constrained environment and a vehicle at a particular (current) location in the constrained environment. When step 608 is executed with steps 602, 604 and 606, execution of steps 610 and 611 cause the vehicle's movement relative to a spline curve 908 to be displayed. The vehicle thus appears to move through the constrained environment relative to spline curve 908.

Regardless of whether step 608 is executed, at step 610, data provided to a transmitter 416 described above and broadcast into the physical embodiment of the constrained environment 904. In the method 600A shown in FIG. 6A, data broadcast at step 610 represents combined 3D model data. At step 611, the 3D model data broadcast at step 610 is rendered. The rendering of 3D model data at step 611, thus takes place after 3D model data is broadcast. Steps 610 and 611 thus inherently require post-transmission rendering of 3D models to take place after the 3D model data is transmitted. In other words, the method shown in FIG. 6A inherently requires the rendering of 3D model data to be performed after the 3D model data is received. In most implementations of method 600A, post-transmission rendering of 3D model data will take place in a vehicle, i.e., by a computer in a vehicle, such as the vehicle 902 depicted in FIG. 9.

For claim construction purposes, in step 610, information, i.e., data, is broadcast from which a “first” representation of the vehicle at the “first” location, can be displayed on a two-dimensional screen. Step 610 does not require that the data that is broadcast to be 3D-model data that requires rendering when the broadcast data is received in or at a vehicle.

3D model manipulation and 3D image rendering may be performed by the processor 408 depicted in FIG. 4. In such an embodiment, information that is broadcast and from which 2D images of a vehicle in a constrained environment, does not require rendering after the information is broadcast.

FIG. 6B depicts an alternate method 600B of displaying a simulated vehicle's simulated movement in a simulated constrained environment. In FIG. 6B, the steps identified by reference numerals 602, 604, 606, 608 are the same as the steps identified by reference numerals 602, 604, 606, 608 of FIG. 6A. The method 600B depicted in FIG. 6B differs from the method 600A depicted in FIG. 6A differ at step 6010 of FIG. 6B, wherein 3D model data representing a constrained environment, a vehicle, and perhaps a spline curve, are combined at step 608 and rendered at 6010 prior to broadcast at step 6011. The alternate method 600B thus requires the 3D model data to be rendered before transmission.

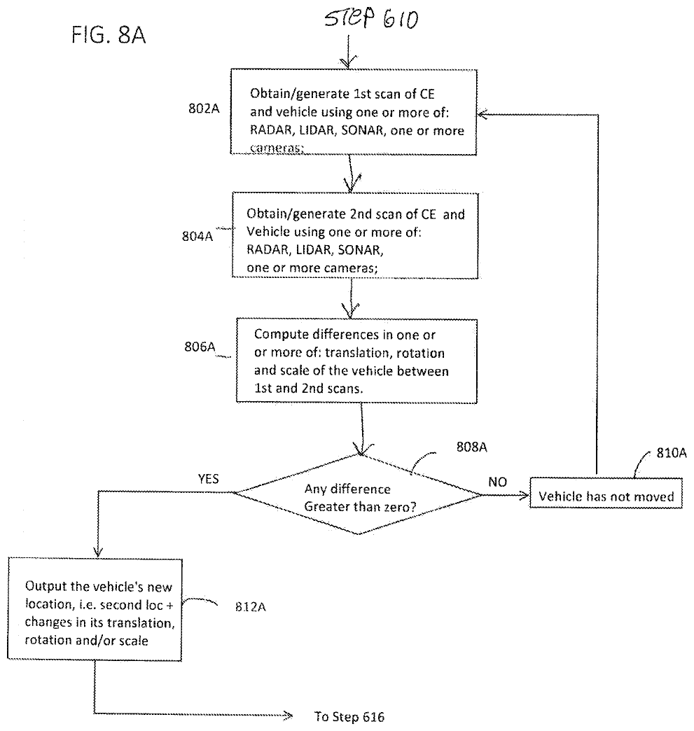

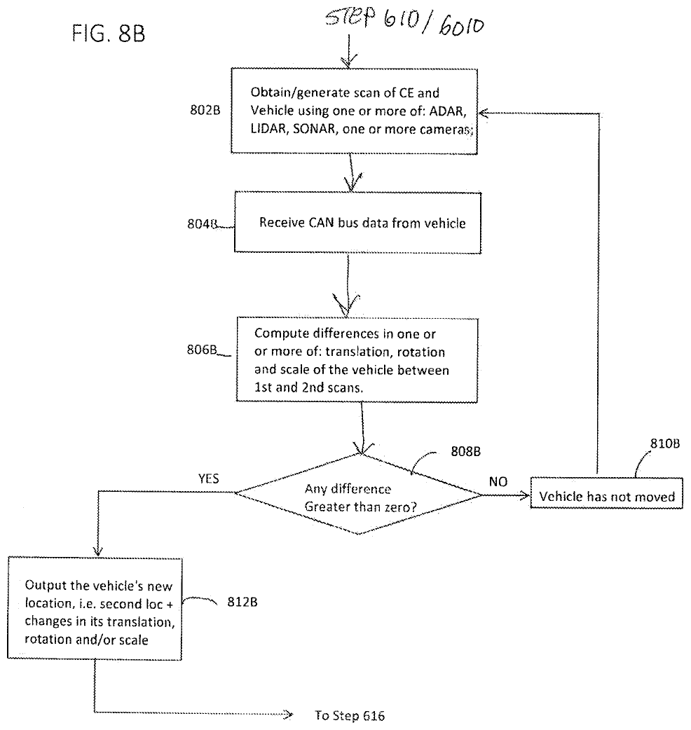

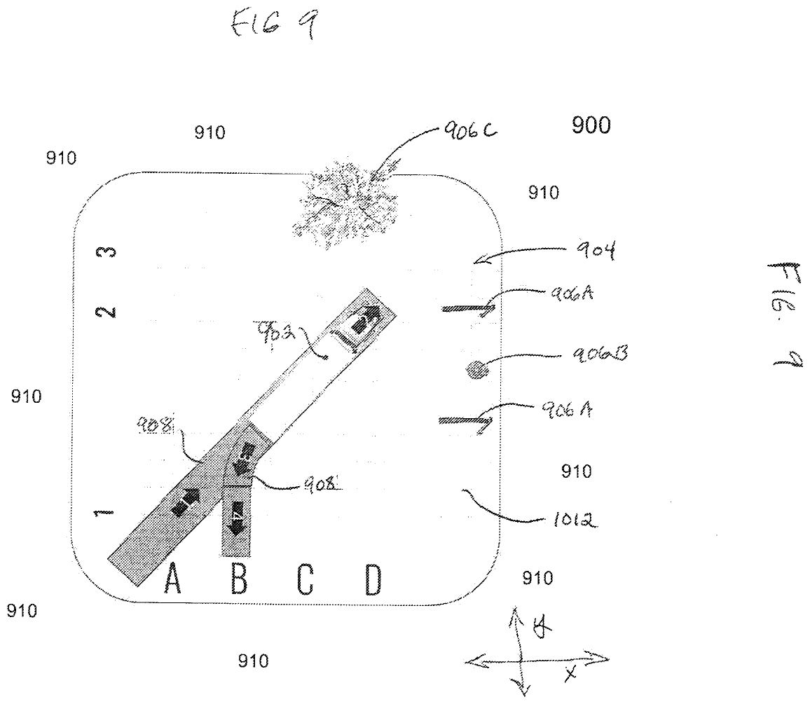

Referring now to both FIG. 6A and 6B, at step 612, a determination is made whether the particular vehicle moved. Movement can be determined by comparing a vehicle's location as determined by a camera, RADAR, LIDAR or SONAR. Some vehicles may also have vehicle movement data on a CAN bus data or data compliant with SAE J1939 standard, which an appropriately configured data can wirelessly broadcast using WI-FI or cell phone 5G, 4G, LTE or other wireless protocols. When a vehicle changes its location as determined at step 612, the distance it moved is determined at step 614. The distance that a vehicle moved is determined by measuring the vehicle's displacement using a camera, RADAR, LIDAR or SONAR or by receiving a motion and distance determination from the vehicle's sensors. FIGS. 8A and 8B depict two alternative implementations of steps 612 and 614.

In FIG. 8A, steps 612 and 614 of FIG. 6A and 6B are implemented by comparing a vehicle's image and location parameters obtained from two temporally different scans. In step 802A, a vehicle's image and location is obtained by RADAR, LIDAR, SONAR or optically by one or more cameras, preferably digital cameras, which may also be stereoscopic cameras. At step 804A, the vehicle is re-scanned. At step 806A, the results of the two scans are compared. When differences exist in images of a vehicle, which images were captured at different times, the vehicle's apparent size or apparent orientation in those two images, will differ due to movement of the vehicle relative to a camera that captured the two images and not because the vehicle's actual size or its orientation changed. A vehicle's movement is thus detected by comparing the apparent size and apparent orientation of the vehicle in successive or temporally-different, i.e., not necessarily successive frames of images captured by a digital camera. Such apparent differences of size or orientation in successive images are thus representative to the vehicle's movement and are determined by computing differences between the data obtained at steps 802A and 804A are tested at step 808A.

At step 808A, a zero difference between the data obtained at step 802A and 802B is considered an indicator that the vehicle did not move. From step 810A, the methods of steps 612 and 614 are repeated until movement is detected at step 808A by a detected or measured difference in what the vehicle's image or location changes over time. If the comparison of data obtained at steps 802A and 802B is greater than zero, the vehicle moved. At step 812A, the new location of the vehicle is determined as is its translation from the previous location, its rotation and its size or scale. It's new location as determined by the second scan of step 804A becomes the “new” location for step 616. A “new” 3D model of the vehicle at the “new” location is determined at step 814A, which is used in step 612.

Referring again to both FIG. 6A and 6B at step 616, a determination is made whether the “new” location determined at step 614 is the end of the spline curve described above.

As used herein, the term “CAN bus” refers to the well-known controller area network (CAN bus) vehicle bus standard, which was designed to allow microcontrollers and devices to communicate with each other. A CAN bus uses a message-based protocol, designed originally for multiplex electrical wiring within automobiles to save on copper, but it can also be used in many other contexts. For each device connected to a CAN bus, the data in a frame is transmitted serially but in such a way that if more than one device transmits at the same time, the highest priority device can continue while the others back off. Frames are received by all devices, including by the transmitting device.

Referring now to FIG. 8B, which is a second embodiment of steps 612 and 614, CAN bus data or J11939-standard data, or J1939-standard-equivalent data, received from the vehicle itself at step 804B determines whether the vehicle moved. CAN bus data, J11939-standard data, or J1939-standard-equivalent data, which quantifies vehicle movement includes but is not limited to tire rotation data from which a translation distance can be calculated. Such data also includes steering angle inclination, from which vehicle rotation can be determined.

At step 806B, differences between a vehicle's translation, rotation or scale (size) indicate the vehicle moved, in which case the method depicted in FIG. 8B proceeds to step 812B wherein the vehicle's “new” location is output (provided) to the processor manipulating the vehicle's 3D model. If there are no differences between a vehicle's translation, rotation or scale, the method proceeds to step 810B, which is a return or loop back to step 802B.

At step 812B, the new location of the vehicle is determined as is its translation from the previous location, its rotation and its size or scale. The new location as determined by the second scan of step 804B becomes the “new” location for step 616. A “new” 3D model of the vehicle at the “new” location is determined at step 812B, which is used in step 616 and subsequent steps.

Those of ordinary skill in the art should recognize that the description above is for illustrative purposes. The true scope of the invention is set forth in the following claims.

What is claimed is:

1. A method of displaying on a display device coupled to a vehicle, a representation of the vehicle's movement in a constrained environment, the method comprising:
combining a 3D-model of the constrained environment with a 3D-model of the vehicle at a first location in the 3D-model of the constrained environment thereby creating a first 3D-representation of the vehicle at the first location in the 3D-model of the constrained environment;
wirelessly broadcasting information, from which the first 3D-representation of the vehicle at the first location in the 3D-model of the constrained environment, can be displayed on a display device.

2. The method of claim 1, further comprising: rendering the 3D-representation of the vehicle in a rendered 3D-model of the constrained environment.

3. The method of claim 2, wherein rendering occurs prior to the wirelessly broadcasting step.

4. The method of claim 2, wherein rendering occurs after the wirelessly broadcasting step.

5. The method of claim 2, wherein rendered 3D-representations of the vehicle in the rendered 3D-model of the constrained environment are at least one of: a first-person view and a third-person view.

6. The method of claim 2, further comprising:
detecting movement of the vehicle from the first location to a second location in the constrained environment;
creating a second 3D-representation of the vehicle at the second location in the 3D-model of the constrained environment; and
wirelessly broadcasting information, from which the second 3D-representation of the vehicle at the second location in the 3D-model of the constrained environment, can be displayed on a display device.

7. The method of claim 6, wherein a representation of at least one of the vehicle's size and orientation at the second location is different than a representation of at least one of the vehicle's size and orientation of the vehicle at the first location.

8. The method of claim 1, further comprising the step of re-sizing at least one of: the 3D model of the vehicle and the 3D model of the constrained environment.

9. The method of claim 1, wherein rendered 3D-representations of the vehicle in a rendered 3D-model of the constrained environment are at least one of: a first-person view and a third-person view.

10. The method of claim 2, additionally comprising:
combining a 3D-model of a spline curve with the first 3D-representation of the vehicle at the first location in the 3D-model of the constrained environment; and
wirelessly broadcasting information, from which the 3D-model of the spline curve and the first 3D-representation of the vehicle at the first location in the 3D-model of the constrained environment can be rendered and displayed on a display device.

11. The method of claim 10, wherein the 3D-model of the spline curve comprises a segment having a first end and an opposing second end, each end of the segment being located at corresponding geometric coordinates in the constrained environment.

12. The method of claim 11 further comprising: wirelessly broadcasting the geometric coordinates of the first and second ends of the segment.

13. The method of claim 10 wherein the 3D-model of the spline curve has a width such that when the 3D-model of the spline curve is rendered and displayed on a display device, the displayed width of the spline curve corresponds to a width required by said vehicle to travel along said spline curve.

14. The method of claim 11, wherein:
the first end of the spline segment comprises spaced-apart first and second vertices;
the second end of the spline segment comprises spaced-apart third and fourth vertices; and
wherein the distance between the first and second vertices when the spline segment is displayed on a display device, and the distance between the third and fourth vertices when the spline segment is displayed on a display device, are different and correspond to a width required by said vehicle to travel along said spline curve without colliding with an object in the constrained environment.

15. The method of claim 6, wherein detecting movement comprises scanning at least part of the constrained environment using at least one of: a camera, RADAR, LIDAR and SONAR.

16. The method of claim 6, wherein detecting vehicle movement comprises wirelessly receiving at least one of: CAN bus data and data compliant with SAE J1939 standard.

17. The method of claim 1, wherein the step of wirelessly broadcasting information comprises wirelessly broadcasting a radio frequency (RF) signal carrying said information into the constrained environment using at least one of: WI-FI, 5G, 4G and LTE, wireless communication protocols.

18. The method of claim 6, wherein the wirelessly broadcast information is broadcast into the vehicle.

19. The method of claim 6, wherein wirelessly broadcasting information, from which the second 3D-representation of the vehicle at the second location in the 3D-model of the constrained environment can be depicted on a display device, comprises rendering the second 3D-represenation of the vehicle at the second location in the 3D-model of the constrained environment.

20. The method of claim 6, additionally comprising the step of: rendering the second 3D-representation of the vehicle at the second location in the 3D-model of the constrained environment, prior to the step of wirelessly broadcasting information.

21. The method of claim 1, wherein the display device is within the vehicle.

22. The method of claim 6, further comprising: displaying on a display device in the vehicle, a rendering of the second 3D-representation of the vehicle at the second location in the 3D-model of the constrained environment.

23. The method of claim 1, further comprising the steps of:
obtaining a 3D-model of the vehicle from a database and determining a 3D-model of the constrained environment from measurements of the constrained environment and its contents, prior to combining a 3D-model of the constrained environment with a 3D-model of the vehicle.
